(19) United States
(12) Patent Application Publication
(10) Pub. No.: US 2016/0115976 A1
(43) Pub. Date: Apr. 28, 2016

(54) Actuator Assembly

(71) Applicant: Mørenot Offshore AS, Søvik (NO)

(72) Inventor: Stig Hurlen, Brattvåg (NO)

(73) Assignee: Mørenot Offshore AS, Søvik (NO)

(21) Appl. No.: 14/895,173

(22) PCT Filed: Jun. 11, 2014
(86) PCT No.: PCT/NO2014/050097

§ 371 Date: Dec. 1, 2015

(30) Foreign Application Priority Data
Jun. 11, 2013 (NO) 20130819

(51) Int. Cl. F15B 20/00; F15B 13/10; F15B 13/06; F15B 11/16

(52) U.S. Cl. CPC F15B 20/004; F15B 11/16; F15B 13/10; F15B 13/06; F15B 2211/205; F15B 2211/255; F15B 2211/41572; F15B 2211/426; F15B 2211/7051; F15B 2211/71; F15B 2211/8623; F15B 2211/8752; F15B 2201/00

(57) ABSTRACT

An actuator assembly includes a first actuator and a hydraulic unit. The first actuator comprises an actuator housing, a piston in the actuator housing, and an actuator rod. The actuator assembly further includes a second actuator. The second actuator comprises an actuator housing, a piston in the actuator housing, and an actuator rod. The piston side of the first actuator faces the piston side of the second actuator and the actuator rods are coaxial.

### CROSS-REFERENCE TO RELATED APPLICATIONS

This application is the U.S. national stage application of International Application PCT/NO2014/050097, filed Jun. 11, 2014, which international application was published on Dec. 18, 2014, as International Publication WO2014/200355 in the English language. The international application is incorporated herein by reference, in entirety. The international application claims priority to Norwegian Patent Application No. 20130819, filed Jun. 11, 2013, which is incorporated herein by reference, in entirety.

### FIELD

The invention relates to an actuator assembly. More specifically, the invention relates to an actuator assembly with two pistons and two actuator rods pointing in opposite directions. The invention also relates to an actuator assembly, which can take a “fail safe” position with a predetermined distance between the free end portions of the two actuator rods.

### BACKGROUND

In marine seismology it is usual to carry out so-called seismic tows, in which several long cables, so-called streamers, and air guns are towed behind a boat. When the air guns are fired, the shock wave will be reflected from the layers in the bedrock and reflections from the shock wave are picked up by so-called streamers, whereupon the signals are interpreted, giving information about the geology of the bedrock. When the streamers are being towed behind a vessel, this is dependent on the ability to keep them apart so that they lie side by side in the longitudinal direction and have a certain distance between them in the transverse direction. The spreading in the transverse direction is normally provided by means of so-called deflectors, also called paravanes. Deflectors are wing-shaped hydrofoils. In the case of marine seismology, the deflectors are, as a rule, mounted on each outer edge of the seismic tow, and the deflectors have such angles of attack relative to the water flow that they bring about stretching in the transverse direction of the tow.

There is often a need to steer the deflectors. The need is connected with the adjustment of the spreading force in the transverse direction, and the control of the direction of the seismic tow. Steering may be done by adjusting the angle of attack of the deflector relative to the water flow. The angle of attack is usually adjusted by changing the relative lengths of the attachment straps of the deflector at the forward edge and at the rear edge of the deflector. In the art, the attachment straps are called “bridle lines” or “door bridles”. The bridle lines are usually attached to a towing block, called a “bridle block” in the art. The bridle block, in turn, is attached to the towline extending in to the vessel pulling the tow. The length adjustment of the bridle lines may be performed by means of mechanical devices. The patent publication NO331840 discloses an adjusting winch for such adjustment of the bridle lines.

When deflectors are being steered, problems may arise if the mechanical device that provides adjustment of the angle of attack fails. This typically happens on an interruption to the power supply to the mechanical device, for example in a power failure. In such situations, it is desirable that the angle of attack of the deflector returns to a predetermined position, a so-called “fail safe” position, until the mechanical device is operative again.

### SUMMARY

The invention has for its object to remedy or reduce at least one of the drawbacks of the prior art or at least provide a useful alternative to the prior art.

The object is achieved through features, which are specified in the description below and in the claims that follow.

The invention relates to an actuator assembly. The actuator assembly is provided with two pistons, and each piston is connected to a respective actuator rod. In an exemplary embodiment, the actuator assembly is shown in a position of application in which each actuator rod is connected, at its end portion, to a bridle line extending from a portion of a deflector to a bridle block. Displacement of one of the pistons of the actuator assembly changes an active length of a bridle line. The actuator assembly is provided with a hydraulic unit, which includes a valve system, the valve system being arranged to return the pistons of the actuator assembly to predetermined positions on an interruption to the power supply.

In a first aspect, the invention relates more specifically to an actuator assembly, the actuator assembly including:
a first actuator, the first actuator comprising an actuator housing, a piston in the actuator housing and an actuator rod; and
a hydraulic unit,
   and the actuator assembly further including:
a second actuator, the second actuator comprising an actuator housing, a piston in the actuator housing and an actuator rod; and
the piston side of the first actuator facing the piston side of the second actuator, and the actuator rods being coaxial.

The actuator housings may form one cylinder. The first actuator may be separated from the second actuator by a partition wall in the cylinder.

The hydraulic unit may include two solenoid valves that, on a loss of electrical energy, bring the actuator-rod side of the first actuator into fluid communication with a pressurized reservoir and the piston side of the second actuator into fluid communication with a reservoir, respectively, so that the actuator assembly takes a “fail safe” position. The working length L of the actuator assembly in the “fail safe” position may be between the shortest working length L−l′ and the longest working length L+l of the actuator assembly.

A deflector is described as well, the deflector including wings, braces and a floating body, and the deflector possibly being provided with a deflector-control apparatus, wherein the deflector-control apparatus may include a double actuator with two actuator rods which are displaced substantially in parallel, and each actuator rod may be attached at its free end portion to a bridle line having first and second end portions, the bridle line may be attached at its first end portion to the actuator rod and the bridle line may be attached at its second end portion to a bridle block.

The deflector may further be provided with an electrically operated hydraulic system for operating the deflector-control apparatus. The hydraulic system may include solenoid valves that, on a loss of electrical energy, bring the actuator-rod side of the first actuator into fluid communication with a pressurized reservoir and the piston side of the second actuator into fluid communication with a reservoir, respectively, so that the deflector-control apparatus takes a “fail safe” position.

The two actuator rods may be displaced coaxially. The hydraulic system may be positioned in the floating body of the deflector.

The deflector-control apparatus of the deflector may include a first actuator comprising a first actuator housing, a first piston and a first actuator rod, and a second actuator comprising a second actuator housing, a second piston and a second actuator rod; the first actuator housing and the second actuator housing may be coaxial and separated by a common wall, so that the first actuator rod projects from the actuator housing in the longitudinal direction of the actuator housing and the second actuator rod projects from the actuator housing on the opposite side relative to the first actuator rod.

### BRIEF DESCRIPTION OF THE DRAWINGS

In what follows, an example of a preferred embodiment is described, which is visualized in the accompanying drawings, in which:

FIG. 1 shows a perspective view of a known deflector attached by bridle lines to a bridle block according to the prior art;

FIG. 2 shows, on another scale a sketch of a seismic tow according to the prior art, viewed from above;

FIGS. 3A-D show, in a simplified and schematic manner, the positions of the pistons in an actuator according to the invention; and

FIGS. 4A-B show, in a simplified and schematic manner, hydraulic diagrams for an apparatus according to the invention, the apparatus shown in A) being in the ordinary operating mode and the apparatus shown in B) being in a so-called “fail safe” position.

### DETAILED DESCRIPTION OF THE DRAWINGS

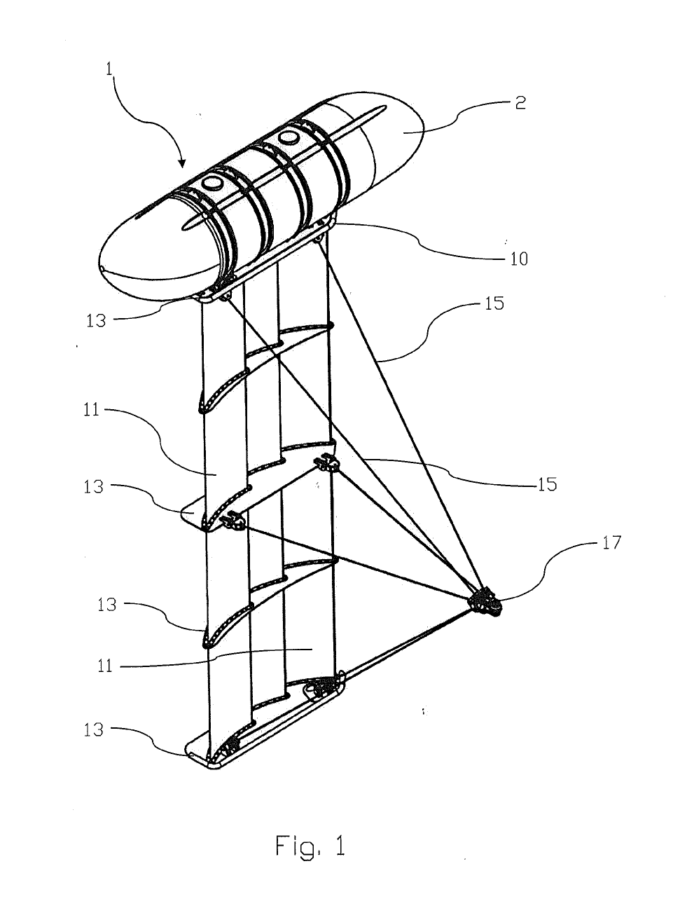

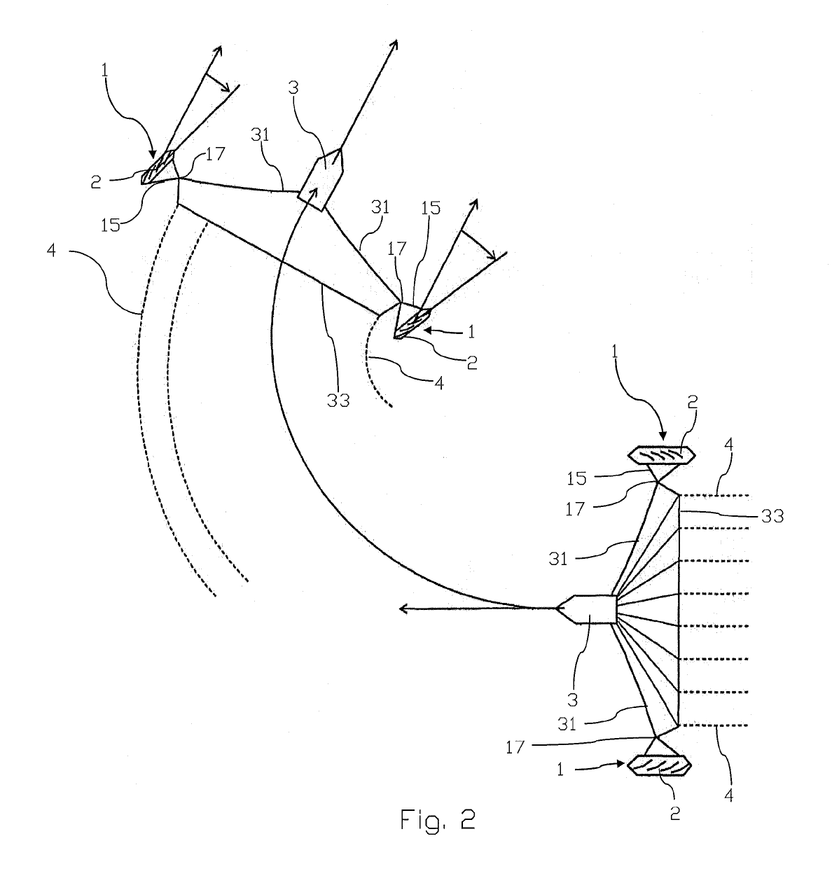

In the figures, the reference numeral 1 indicates a deflector. The deflector 1 shown in FIG. 1 is known in the art and is described briefly for the understanding of one aspect of the invention. The deflector 1 includes a plurality of bow-shaped wings or foils 11. In the position of application, the wings 11 are oriented vertically in the water column. The wings 11 are held fixed by a plurality of braces 13 standing substantially perpendicularly to the longitudinal direction of the wings 11. The deflector 1 is provided with a floating body or a pontoon 2 at its upper portion 10. To some of the braces 13, two bridle lines 15 are attached, spaced along the longitudinal direction of the brace 13. The bridle lines 15 extend from the brace 13 to a bridle block 17. From the bridle block 17, a towline 31 extends as shown in FIG. 2 to a vessel 3.

FIG. 2 schematically shows the vessel 3 towing seismic cables 4, before and after the vessel 3 has changed its course. The course of the vessel 3 is shown by a solid arrow out from the bow of the vessel 3. Carrying out such a tow belongs to the prior art. Extending from the vessel 3, there are a port towline 31 and a starboard towline 31. The towline 31 extends from the vessel 3 to the bridle block 17. The deflector 1 is attached to the bridle block 17 by the bridle lines 15. Extending between the bridle block 17 on the port side and the bridle block 17 on the starboard side, there is a front line 33. The seismic cables 4 extend astern from the vessel 3 to the front line 33 and further on, substantially side by side astern from the front line 33. Via the bridle lines 15 and the bridle block 17, the deflectors 1 will pull on the front line 33, keeping it stretched astern of the vessel 3. As shown in FIG. 2, the floating bodies 2 of the deflectors 1 will substantially follow the course of the vessel 3 when the course is straight forwards. When the vessel 3 changes its course, the port and starboard deflectors 1 will be moved by different distances as shown in FIG. 2. To be able to maintain the spreading force at the front line 33, it is desirable that the port deflector 1 and the starboard deflector 1 attack the water at different angles. This is shown schematically by different sizes of the angles drawn for the deflectors 1 drawn at the top of FIG. 2. Various apparatuses for changing the angle of attack of the deflector 1 are known, and these are known to a person skilled in the art.

After the vessel 3 has carried out a change of course, the angles of attack of the deflectors 1 are controlled in such a way that they take the angles of attack shown at the bottom of FIG. 2. If a fault should occur in the system for controlling the angle of attack of the deflector 1, the deflectors 1 will either stretch the front line 33 with a spreading force greater than necessary, increasing the towing resistance, or the deflectors 1 will move towards each other and the width of the tow will decrease.

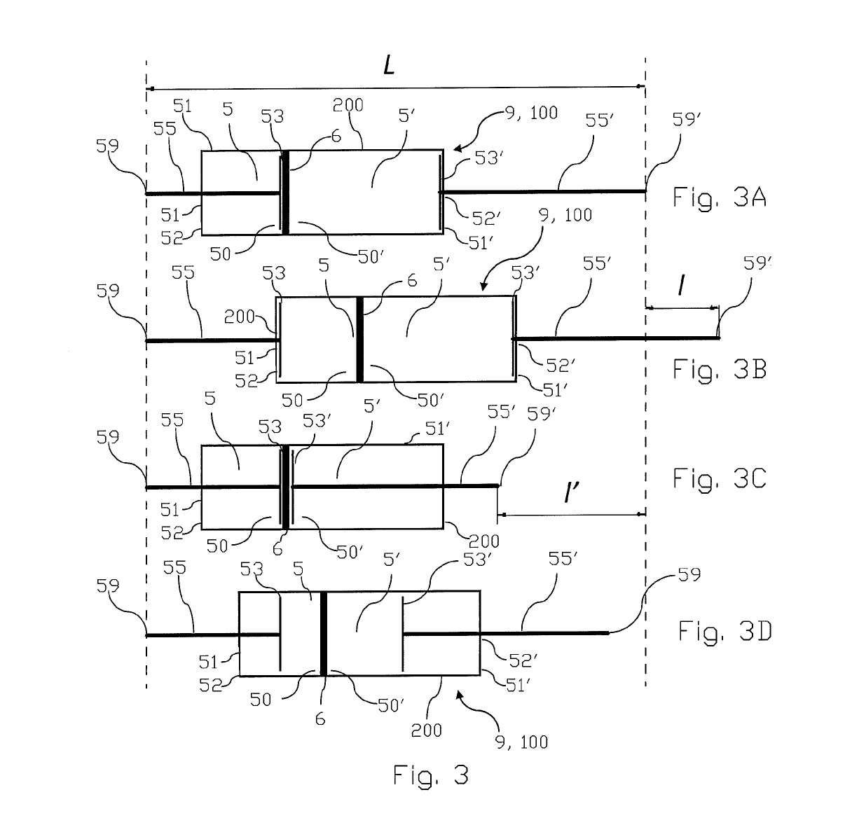

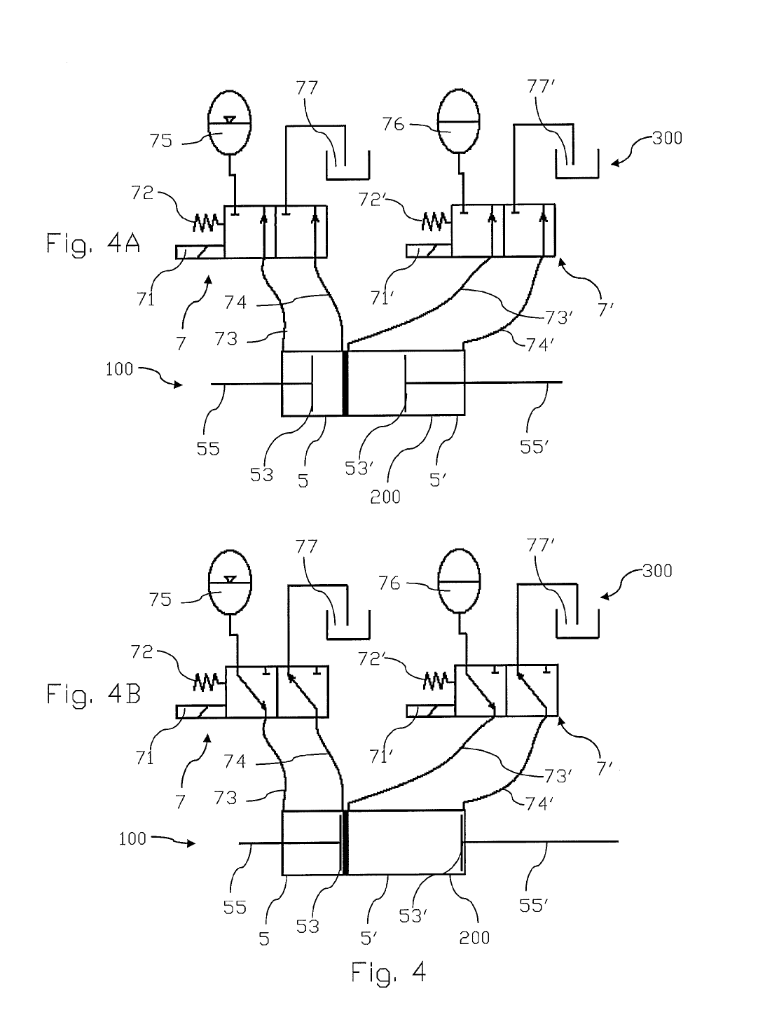

The invention is shown schematically in FIGS. 3 and 4. The invention relates to an actuator assembly 100. In the description and drawings, the actuator assembly 100 is shown as a deflector-control apparatus 9, which may be a relevant area of application for the actuator assembly 100. The person skilled in the art will know that such an actuator assembly may also have other areas of application.

The actuator assembly 100 includes two independent linear actuators 5, 5′. A first actuator 5 comprises an actuator housing 51, a piston 53 and an actuator rod 55 connected to the piston 53. A second actuator 5′ comprises an actuator housing 51′, a piston 53′ and an actuator rod 55′ connected to the piston 53′. The longitudinal axes of the actuator rods 55, 55′ are coaxial. The free end portions 59, 59′ of the actuator rods 55, 55′ are attached to a bridle line 15 each (not shown in FIGS. 3 and 4). FIG. 3 shows schematically the distance between the end portion 59 of the actuator rod 55 and the end portion 59′ of the cooperating actuator rod 55′. FIG. 3A shows that the distance between the end portions 59 and 59′ is a working length L. This corresponds to the desired distance L between the end portions 59, 59′ on a failure in the power supply to the deflector-control apparatus 9. The working length L is achieved by the piston 53 in the actuator 5 being displaced to its maximum towards the bottom portion 50 of the actuator housing 51 while, at the same time, the piston 53′ is displaced to its maximum towards the top portion 52′ of the actuator housing 51′. By active control of the deflector-control apparatus 9, the working length between the end portions 59 and 59′ may be L+l as shown in FIG. 3B. The distance or working length L+l is the maximum working length achievable between the end portions 59 and 59′. The working length L+l is achieved by the piston 53 in the actuator 5 being displaced to its maximum towards the top portion 52 of the actuator housing 51 while, at the same time, the piston 53′ is displaced to its maximum towards the top portion 52′ of the actuator housing 51′.

Through active control of the deflector-control apparatus 9, the distance or working length between the end portions 59 and 59′ may be L−l′ as shown in FIG. 3C. The distance L−l′ is the smallest working length achievable between the end portions 59 and 59′. The distance L−l′ is achieved by the piston 53 in the actuator 5 being displaced to its maximum towards the bottom portion 50 of the actuator housing 51 while, at the same time, the piston 53′ is displaced to its maximum towards the bottom portion 50′ of the actuator housing 51′.

The deflector-control apparatus 9 may be operated in such a way that the distance between the free end portions 59 and 59′ constitutes a distance between L−l′ and L+l, as shown in FIG. 3D.

In FIGS. 3A-3D, the position of the free end portion 59 is kept constantly at the left-hand broken line to illustrate the distances L, l and l′. The person skilled in the art will understand that the actuator housing 51, 51′ is fixed to a suitable surface (not shown) and that the pistons 53, 53′ and actuator rods 55, 55′ move relative to the actuator housing 51, 51′.

In FIG. 3, the two actuators 5 and 5′ are shown in an embodiment that is in accordance with the invention. The actuator 5 is shown back to back with the actuator 5′ so that the piston side of the first actuator 5 faces the piston side of the second actuator 5′. The actuator rod 53 of the first actuator 5 projects from the actuator housing 51 in the longitudinal direction of the actuator housing 51. The second actuator rod 55′ projects from the actuator housing 51′ in the longitudinal direction of the actuator housing 51′ in the opposite direction to that of the first actuator rod 55. In one embodiment, the actuator housing 51 and the actuator housing 51′ form a cylinder 200. The actuator 5 is shown separated from the actuator 5′ by a partition wall 6 in the cylinder 200. The longitudinal axis of the actuator rod 55 coincides with the longitudinal axis of the actuator rod 55′. Such an assembly of two actuators 5 and 5′ in one cylinder 200 gives a compact double-acting actuator assembly 100.

The person skilled in the art will know that the operation of a deflector-control apparatus as described may also be achieved by two actuators of a kind known per se being positioned side by side (not shown). The longitudinal axes of the actuator rods will be substantially parallel. The actuators will face opposite directions. Such an assembly of two actuators has the drawback of the assembly being prone to twisting as the longitudinal axes of the actuator rods are not coaxial.

The deflector-control apparatus 9 may be attached to the brace 13 of the deflector 1 (not shown). One end portion of the bridle line 15 is attached to the first free end portion 59, 59′ of the actuator rod 55, 55′. The bridle line 15 is passed over a pulley (not shown) on the brace 13 to the bridle block 17. The other free end portion of the bridle line 15 is attached to the bridle block 17. By the active length of the bridle line 15 is meant the distance along the bridle line 15 from the bridle block 17 to the pulley on the brace 13. When the piston 53, 53′ with the actuator rod 55, 55′ is displaced in the actuator 5, 5′, the active length of the bridle line 15 is altered.

The actuator assembly 100 is supplied with hydraulic fluid from a hydraulic unit 300. The deflector 1 may be provided with a remote-controlled hydraulic unit 300. The hydraulic unit 300 includes at least one pump (not shown) which may be an electrically driven pump. The electrically driven pump may be supplied with electrical energy from an aggregate (not shown) on the deflector 1 or from an electric battery (not shown) on the deflector 1 when the hydraulic unit 300 is positioned on the deflector 1. The aggregate and the battery may be placed in the floating body 2 of the deflector 1. In an alternative embodiment, the aggregate may charge the battery. The hydraulic unit 300 includes valves of a kind known per se (not shown), and the hydraulic unit 300 further includes two solenoid valves 7, 7′. The solenoid valves 7, 7′ are shown as a principle drawing in FIG. 4. Each solenoid valve 7, 7′ includes an electromagnetic coil 71, 71′ and a spring 72, 72′.

During normal operation, the at least one pump will supply the actuators 5, 5′ with hydraulic fluid through hydraulic hoses 73, 73′, 74, 74′ and valves direct hydraulic fluid to the actuator-rod side and the piston side of the piston 53, 53′ to displace the piston 53, 53′ in the actuator housing 51, 51′ as known within the art. This is shown in a simplified and schematic manner in FIG. 4A.

The hydraulic unit 300 further includes a pressurized reservoir 75, a reservoir 76 and at least one receiving reservoir 77, 77′. On a loss of electrical energy, the spring 72, 72′ will bring the valve 7, 7′ to its “fail safe” state. The hydraulic hose 73 is connected through the valve 7 so that the pressurized reservoir 75 will be in fluid communication with the actuator-rod side of the piston 53. The piston 53 is thereby displaced inwards in the actuator housing 51. Hydraulic fluid on the piston side of the piston 53 flows to the receiving reservoir 77 through the hydraulic hose 74. The piston 53 thereby takes the position as shown in the simplified and schematic FIGS. 3A and 4B. The hydraulic hose 74′ is connected through the valve 7′ so that the receiving reservoir 77′ will be in fluid communication with the actuator-rod side of the piston 53′ while the hydraulic hose 73′ will be in fluid communication with the reservoir 76. The piston 53′ is displaced outwards in the actuator housing 51′ by the pulling force from the bridle line 15 that is attached to the end portion 59′ of the actuator rod 55′. Hydraulic fluid on the actuator-rod side of the piston 53′ will flow to the receiving reservoir 77′ through the hydraulic hose 74′ and hydraulic fluid will flow from the reservoir 76 to the piston side of the piston 53′ through the hydraulic hose 73′.

The invention is shown used in connection with the control of a deflector 1 in connection with marine seismology. The invention may also be used for other types of tows in which it is desirable to achieve stretching in the transverse direction of the tow. Examples of such tows are minesweeping and the towing of oil booms and oil-collecting equipment on a water surface.

The invention may also be used in other connections in which there is a need for a compact double-acting actuator assembly 100. The invention may be used where there is a need for an actuator assembly 100 which can take a “fail safe” working length that lies between the shortest working length L−l′ and the longest working length L+l of the actuator.

It should be noted that all the above-mentioned embodiments illustrate the invention, but do not restrict it, and persons skilled in the art may construct many alternative embodiments without departing from the scope of the dependent claims. In the claims, reference numerals in brackets are not to be considered restrictive. The use of the verb “to comprise” and its various forms, does not exclude the presence of elements or steps that are not mentioned in the claims. The indefinite article a or an in front of an element does not exclude the presence of several elements of that kind. The fact that some features are stated in mutually different independent claims, does not indicate that a combination of these features cannot be used with advantage.

1. An actuator assembly, the actuator assembly comprising:
a first actuator comprising an actuator housing, a piston in the actuator housing and an actuator rod;
a hydraulic unit; and
a second actuator comprising an actuator housing, a piston in the actuator housing and an actuator rod;
wherein the piston side of the first actuator faces the piston side of the second actuator and the actuator rods are coaxial.

2. The actuator assembly according to claim 1, wherein the actuator housings form one cylinder.

3. The actuator assembly according to claim 2, wherein the first actuator is separated from the second actuator by a partition wall in the cylinder.

4. The actuator assembly according to claim 1, wherein the hydraulic unit includes two solenoid valves that, on a loss of electrical energy, bring the actuator-rod side of the first actuator into fluid communication with a pressurized reservoir and the piston side of the second actuator into fluid communication with a reservoir, respectively, so that the actuator assembly takes a “fail safe” position.

5. The actuator assembly according to claim 4, wherein, in the “fail safe” position, the working length L is between the shortest working length L−l′ and the longest working length L+l of the actuator the actuator assembly.
